(19) United States
(12) Patent Application Publication
(10) Pub. No.: US 2009/0047842 A1
(43) Pub. Date: Feb. 19, 2009

(54) Power connector with two housing parts mounted to each other for holding contact terminals therein

(75) Inventors: Xiao-Li Li, Kunshan (CN); Ping-Sheng Su, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 12/228,740

(22) Filed: Aug. 15, 2008

(30) Foreign Application Priority Data
Aug. 15, 2007 (CN) 200720042906.5

(51) Int. Cl. H01R 24/00

(52) U.S. Cl. 439/685

(57) ABSTRACT

A power connector (100) includes an insulator (2) and a cap (1). The insulator defines a bottom wall (242) and three mounting holes (21, 22 and 23) extending upwards from the bottom wall, the three mounting holes array in a triangle along a vertical surface, and each mounting hole opens forwards and upwards adapted for receiving a terminal (3). The cap is slidably mounted on the insulator, and comprises a plate (14) extending vertically to cover front surfaces of the mounting holes of the insulator and a roof (12 and 13) extending horizontally from an upper end of the plate to cover upper surfaces of the mounting holes. A wedge (241) is formed on the bottom wall of the insulator, and a nose (145) with a dent (1451) depressed therein extends horizontally from an lower end of said plate adapted for engaging with said wedge.

### CROSS-REFERENCE TO RELATED APPLICATIONS

This application is related to a copending U.S. patent application filed on Aug. 15, 2008 and entitled “Power Connector With Sealed Inner Base Member”, both of which have the same assignee as the present invention.

### BACKGROUND OF THE INVENTION

1. Field of the Invention

This invention generally relates to a power connector, and more particularly, to a kind of power connector with two housing parts mounted to each for holding contact terminals therein.

2. Description of the Prior Art

Power plug connector assemblies are more and more widely used in the connection of various home electric appliances now, thus the manufacturers and researchers have spent more and more resource to design a power plug connector assembly which is secure and easy to be manufactured. Generally, the power plug connector assembly has two-pole or three-pole electrical pin therein, and the three-pole power plug connector assembly is more secure during use, so the three-pole power plug connector assembly is widely used in the home electric appliances now.

Chinese Patent Issue No. CN 2446564Y disclosed a kind of three-pole power connector, please referring to FIGS. 5-6 in the above mentioned patent, which comprises an inner base member 3 and three terminals 4 held in the inner base portion 3. The inner base member 3 has a pair of upper and lower members 31 and 32 assembled to each other, the lower member 32 defining a bottom wall 327 with a depression 329 thereof, the upper member 31 having a finger 314 with a hook 315 thereof. The hook 315 is inserted into the depression 329 and engages with the bottom wall 327 so that the upper and bottom members 31 and 32 are held together. In general, a casing is molded over the upper and lower members 31 and 32. However, because the depression 329 of the lower member 32 has to be deep enough to receive the hook 315 of the upper member 31, the casing is difficult to be molded over the depression 329.

Hence, an improved power connector is desired to overcome the above problem.

### BRIEF SUMMARY OF THE INVENTION

It is an object of the present invention to provide a power connector with an improved inner base portion which has a stable structure and facilitates the forming of an outer casing.

In order to attain the object above, a power connector according to the present invention comprises an insulator and a cap. The insulator defines a bottom wall and three mounting holes extending upwards from the bottom wall, the three mounting holes array in a triangle along a vertical surface, and each mounting hole opens forwards and upwards adapted for receiving a terminal. The cap is slidably mounted on the insulator, and comprises a plate extending vertically to cover front surfaces of the mounting holes of the insulator and a roof extending horizontally from an upper end of the plate to cover upper surfaces of the mounting holes. A wedge is formed on the bottom wall of the insulator, and a nose with a dent depressed therein extends horizontally from an lower end of said plate adapted for engaging with said wedge.

It is another object of the present invention to provide a power connector with an improved inner base portion which has a stable structure and facilitates to be disassembled.

In order to attain the object above, a power connector according to the present invention comprises an insulator and a cap. The insulator defines a mounting hole for receiving a terminal therein, and the mounting hole extends horizontally and opens forwards. The cap is removably mounted on the insulator, and comprises a plate extending vertically to cover a front surface of the mounting hole of the insulator and a nose extending horizontally and backwards from an lower end of said plate. A wedge is formed on a bottom wall of the insulator, and a dent is depressed on said nose for receiving said wedge to keep the insulator and the cap together. The dent of the nose forwards extends through said plate of the cap to facilitate a tool to unlock the nose and the wedge.

Other objects, advantages and novel features of the invention will become more apparent from the following detailed description of the present embodiment when taken in conjunction with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is an assembled view of a power connector in accordance with the present invention;

FIG. 2 is a view similar to FIG. 1, but viewed from another aspect;

FIG. 3 is an exploded, perspective view of the power connector shown in FIG. 1;

FIG. 4 is a view similar to FIG. 3, but viewed from another aspect;

FIG. 5 is a cross-sectional view of FIG. 2 taken along lines 5-5.

### DETAILED DESCRIPTION OF THE INVENTION

Reference will now be made in detail to the preferred embodiment of the present invention.

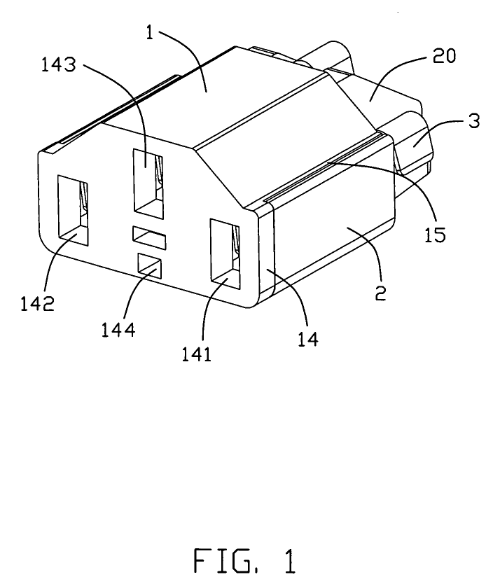

Please referring to FIGS. 1-3, a power connector in accordance with the present invention comprises a housing, a plurality of conductive terminals 3 disposed in the housing, a flat cable (not shown) electrically connecting with the terminals 3, and a cover (not shown) molded over the housing and the cable. The housing is composed of a first housing 1 and a second housing 2 engaging with each other.

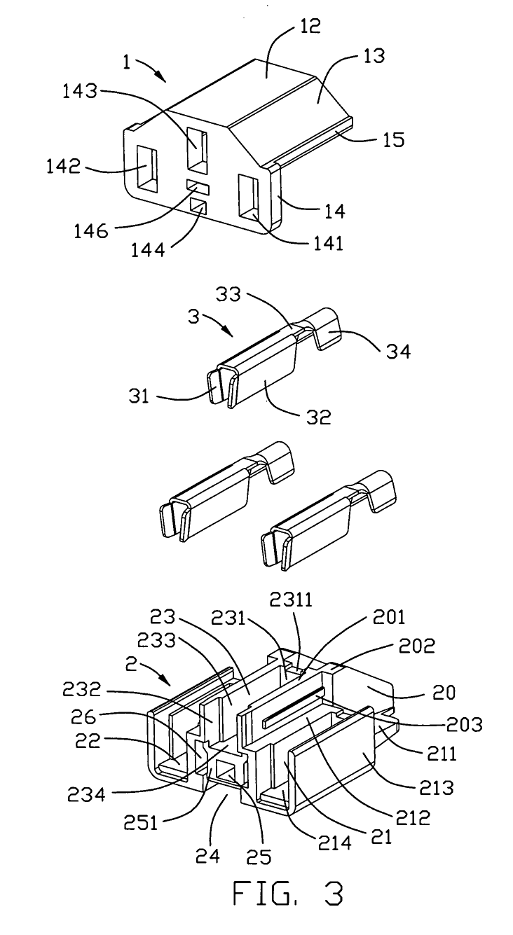

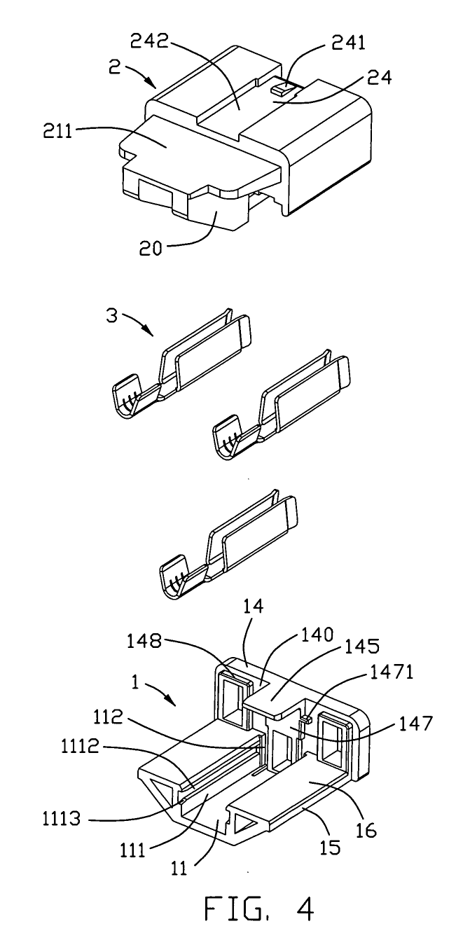

Referring to FIGS. 3-4, the first housing 1 has a cross-section of trapezoid, and defines an upper flat surface 12 and a pair of inclined surfaces 13. The first housing 1 configurates a groove 11 with front and rear inner walls 111 and 112 thereof at the center, and a guide slot 1112 with a chamfer 1113 at the end thereof is depressed in each front inner wall 111. A plate 14 with three rectangular insertion holes 141, 142 and 143 arrayed in a triangle is formed in the front of the first housing 1, the third insertion hole 143 disposed in the center and communicating with the groove 11, the first and second insertion holes 141 and 142 disposed beneath the third insertion hole 143. A pair of holes 144 and 146 are formed under the third insertion hole 143 between the first and second insertion holes 141 and 142. The plate 14 has an inner surface 140 with a nose 145 thereon, the nose 145 disposed above the groove 11 and comprising a dent 1451 communicating with the groove 11. A plurality of rectangular frames 148 protrude from the inner surface 140 of the plate 14 and communicate with the corresponding insertion holes 141, 142 and 143. A projection 147 with a pair of embossments 1471 at opposite sides thereof is formed to connect the frame 148 disposed at the center and the nose 145. The hole 146 is a blind hole and opposite to the projection 147.

The second housing 2 is separated into first, second and third mounting holes 21, 22 and 23 communicating with the corresponding insertion holes 141, 142 and 143 by a pair of separators 20. Each separators 20 comprises a first separator 201 and a second separator 202 extending backwards and outwards from the front separator 201. A supporting plate 211 extends backwards from a rear end of the mounting holes 21, 22 and 23. A pair of guiding posts 203 are formed on outer surfaces of the first separator 201 and extend backwards toward the second separator 202. A pair of platforms 212 respectively connect the separators 20 to sidewalls of the first and second mounting holes 21 and 22, and stand in a horizontal plane. Bottom surface 242 of the second housing 2 has a depression 24 with a wedge 241 thereof at the center, and the front of depression 24 is narrower than the rear. There are a pair of L-shaped gaps 26 and a rectangular opening 25 between the third mounting hole 23 and the depression 24.

A stopper 231 with a nick 2311 thereof lies at the rear end of each mounting hole 21, 22 and 23. The third mounting hole 23 comprises a front cave 232, a rear cave 233 narrower than the front cave 232 and communicating with the front cave 232, and a bottom wall 234. The first and second mounting holes 21 and 22 have similar constructions to the third mounting hole 23.

The terminal 3 comprises a mating portion 31, a body portion 32 extending backwards from the mating portion 31, a tail 34 adapted for holding a cable, and an engaging portion 33 connecting the body portion 32 and the tail 34.

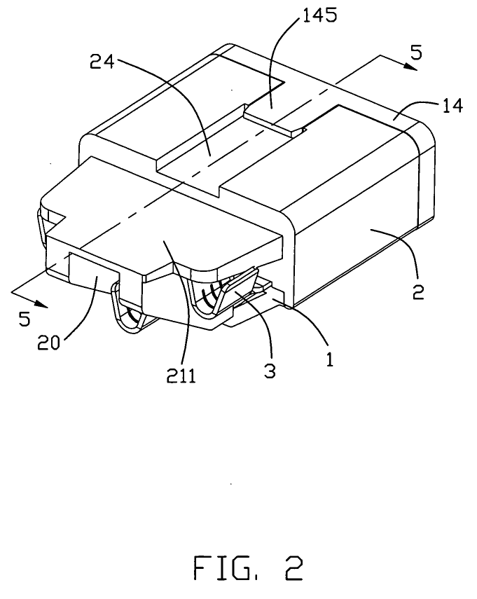

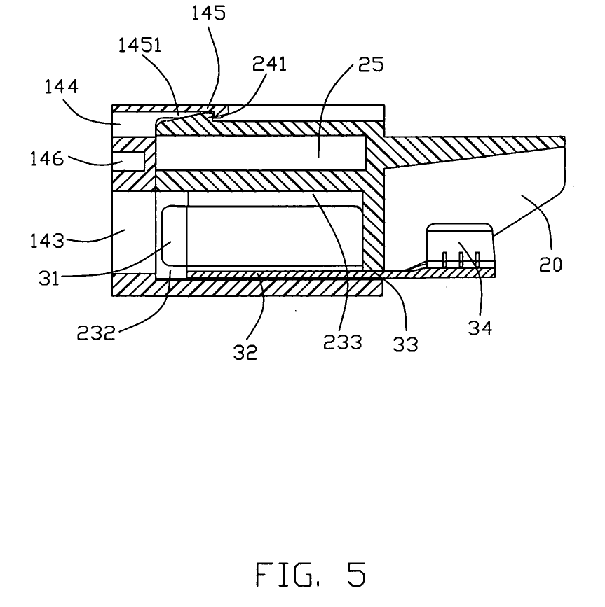

Please referring to FIGS. 2-5, at first, the terminals 3 with a cable (not shown) therein are mounted in the corresponding mounting holes 21, 22 and 23 of the second housing 2, with the mating portion 31 and the body portion 32 respectively received in the front and rear caves 232 and 233, the engaging portion 33 disposed in the nick 2311 of the stopper 231, and the tail 34 and the cable (not shown) supported by the supporting plate 211. Secondly, the rear portion of the first housing 1 is placed on the front portion of the second housing 2, with the bottom surface 16 of the first housing 1 abutting against the platforms 212 of the second housing 2 and the guiding posts 203 of the second housing 2 inserted into the guide slots 1112 of the first housing 1. The engaging portions 15 of the first housing 1 engage with outer sidewalls of the first and second mounting holes 21 and 22. Thirdly, the guiding posts 203 slide forwards along the guide slots 1112 till the first and second housings 1 and 2 are completely assembled. At the same time, the nose 145 of the first housing 1 is inserted into the depression 24 of the second housing 2 and engages with the wedge 241 of the depression 24. Finally, a cover (not shown) is molded over the housing and the cable.

When it is needed to disassemble the first and second housings 1 and 2, a tool (not shown) is inserted into the hole 144 and raises the nose 145. Therefore, the locking of the nose 145 and the wedge is relieved.

It is to be understood, however, that even though numerous, characteristics and advantages of the present invention have been set fourth in the foregoing description, together with details of the structure and function of the invention, the disclosed is illustrative only, and changes may be made in detail, especially in matters of number, shape, size, and arrangement of parts within the principles of the invention to the full extent indicated by the broad general meaning of the terms in which the appended claims are expressed.

What is claimed is:

1. A power connector, comprising:
an insulator defining a bottom wall and three mounting holes extending upwards from the bottom wall, the three mounting holes arraying in a triangle along a vertical surface, each mounting hole opening forwards and upwards adapted for receiving a terminal; and
a cap slidably mounted on the insulator, the cap comprising a plate extending vertically to cover front surfaces of the mounting holes of the insulator, and a roof extending horizontally from an upper end of the plate to cover upper surfaces of the mounting holes;
wherein a wedge is formed on the bottom wall of the insulator, and a nose with a dent depressed therein extends horizontally from an lower end of said plate adapted for engaging with said wedge.

2. The power connector as recited in claim 1, wherein a depression is depressed in the bottom wall of the insulator, and the wedge is formed in said depression.

3. The power connector as recited in claim 2, wherein the wedge forms a inclined surface at its front end to guide the nose.

4. The power connector as recited in claim 1, wherein the wedge forms a inclined surface at its front end to guide the nose.

5. The power connector as recited in claim 1, wherein said dent of the nose forwards extends through said plate of the cap to facilitate the formation of said dent when the cap is formed.

6. The power connector as recited in claim 5, wherein a depression is depressed in the bottom wall of the insulator, and the wedge is formed in said depression.

7. The power connector as recited in claim 5, wherein a supporting plate is formed at the rear of the insulator to support a tail of said terminal.

8. The power connector as recited in claim 5, wherein a guide slot is formed integrally with the cap, and a guiding post is formed integrally with the insulator to engage with said guide slot.

9. The power connector as recited in claim 1, wherein a supporting plate is formed at the rear of the insulator to support a tail of said terminal.

10. The power connector as recited in claim 1, wherein a guide slot is formed integrally with the cap, and a guiding post is formed integrally with the insulator to engage with said guide slot.

11. A power connector, comprising:
an insulator defining a mounting hole for receiving a terminal therein, the mounting hole extending horizontally and opening forwards; and
a cap removably mounted on the insulator, the cap comprising a plate extending vertically to cover a front surface of the mounting hole of the insulator, and a nose extending horizontally and backwards from an lower end of said plate;
wherein a wedge is formed on a bottom wall of the insulator, and a dent is depressed on said nose for receiving said wedge to keep the insulator and the cap together;
wherein said dent of the nose forwards extends through said plate of the cap to facilitate a tool to unlock the nose and the wedge.

12. The power connector as recited in claim 11, wherein the wedge forms a inclined surface at its front end to guide the locking and unlocking.

13. The power connector as recited in claim 12, wherein a depression is depressed in said bottom wall of the insulator, and the wedge is formed in said depression.

14. The power connector as recited in claim 11, wherein a depression is depressed in said bottom wall of the insulator, and the wedge is formed in said depression.

15. The power connector as recited in claim 11, wherein the mounting hole opens upwards, and a roof extends horizontally and backwards from an upper end of the plate to cover an upper surface of the mounting hole.

16. A power connector comprising:
an insulator defining a mounting hole for receiving a terminal therein, the mounting hole extending horizontally through a front surface of the insulator and open to an exterior forwards; and
a cap removably mounted on the insulator, the cap comprising a plate covering said front surface, and a nose extending backwards from said plate;
wherein a forward wedge is formed on a wall of the insulator, and a dent is depressed on said nose for retainably receiving said wedge to keep the insulator and the cap together;
wherein said dent of the nose forwards extends through said plate of the cap to facilitate an external tool to be rearwardly inserted thereinto through said plate for moving along an oblique section of the wedge and outwardly deflecting the nose to unlock the nose from the wedge.
